(19) United States
(12) Patent Application Publication
(10) Pub. No.: US 2014/0125554 A1
(43) Pub. Date: May 8, 2014

(54) APPARATUS AND ALGORITHM TO IMPLEMENT SMART MIRRORING FOR A MULTIPLE DISPLAY SYSTEM

(71) Applicant: SHANGHAI POWERMO INFORMATION TECH. CO. LTD., Shanghai (CN)

(72) Inventors: Qi Pan, Shanghai (CN); Xiong-Hui Guo, Shanghai (CN); Jian-Jing Shen, Shanghai (CN); Zhi-Peng Yang, Shanghai (CN); Xing Li, Shanghai (CN)

(73) Assignee: SHANGHAI POWERMO INFORMATION TECH. CO. LTD., Shanghai (CN)

(21) Appl. No.: 13/671,515

(22) Filed: Nov. 7, 2012

(51) Int. Cl. G06T 3/40

(52) U.S. Cl. CPC G06T 3/4092
USPC 345/2.2

(57) ABSTRACT

Method and system for mirroring multimedia content for sharing between multiple display devices is provided. Preferred usage configuration modes for smart mirroring for multiple display system are provided, in which multiple sets of display frame buffers can be provided in which each set of compatible display frame buffer is correspondingly allocated for one display device having a particular resolution. Preferred usage configuration modes are adapted for smaller screen, larger screen, and balanced usage between smaller screen and larger screen together. Dynamic switching between preferred usage configuration modes is available. System level API and inherit support at hardware side of the display devices are configured to allow for rendering of various display frame buffers to various display devices. Algorithm for implementing smart mirroring includes setting rendering resolution on respective display devices, and rendering one frame buffer to two displayed screens simultaneously, or two different frame buffers to two displayed screens.

### BACKGROUND OF THE INVENTION

1. Field of the Invention

The present disclosure relates to a method and system to smartly mirror display content from one display device to another display device, and in particular to a method and system for mirroring images, videos, multimedia, and/or applications display content for sharing among multiple number of display devices.

2. Description of Related Art

In recent years, multimedia display system containing a multiple number of display devices configured together to show multimedia videos has become popular among consumers. Typically, people would take a smaller device (i.e. laptop, smartphone, tablet, etc.) to connect to a larger external display devices (i.e. HDTV, video projector etc.), and the data connection between the connected display devices can be realized through a wired cable (such as via RGB, HDMI cable) or a wireless connection (such as via WIFI display, WIDI etc).

Because the connected-together mirroring of multiple display devices usually are not operating under at the same image resolutions, thus the traditional method to render image data to multiple number of display devices is typically done by rendering the images configured at the smallest or lowest supported resolution among the multiple display devices, and then to take the lower-quality images to be upscaled to higher-quality images of the larger display screen that is performing the mirroring. Some of the typical multiple display mirroring examples include the following: (1) a modern state-of-the art PC is connected to an out-dated projector and the higher resolution of the PC is adjusted to the lower resolution that the projector can support, so that the actual displayed images can still be the full screen configured at a lower resolution or can instead be only occupying a certain part of the full screen of the PC. (2) A PC is connected to a 1080P full HD TV, and because the PC does not support the 1080p HD resolution, thus the actual displayed images on the full HD TV is up-scaled from the lower image resolution of the PC.

Usually the images provided from an application resource is not a vector-based image in conventional methods for connected-together mirroring of multiple display devices, thus even if the original frame buffer is rendered to fit the largest display device, the down-scaled image configured for the smaller display device will have some degree of image distortion. Sometimes the application will create several layouts configured in various resolutions, i.e. for example, one layout can be configured for a mobile phone version, while another layout can be configured for a tablet version; thus it is possible that when switching between one usage configuration mode to another usage configuration mode, the layout will be different. Under conventional usage configuration modes for mirroring of multiple display devices, the application is not required to be aware that it needs to support various display devices simultaneously, by having it to be able to only provide loss-less rendering in just one of the resolutions of the respective connected together display devices, and the other displays for the other display devices configured in various resolutions will thereby achieve rendering distortion.

Conventional techniques for mirroring display content from one display device to another display device, can be illustrated in the following examples: (1) a smartphone mirroring to a HDTV under landscape mode: FIGS. 1a˜1b show one smartphone operating under landscape mode, while the mirrored displayed image on one HDTV that is wirelessly connected to the smartphone is also operating under landscape mode, in which FIG. 1a shows a black border created on the top and bottom edges of the displayed image of the HDTV, respectively, and FIG. 1b shows a black border created on the right and left edges of the displayed image of the HDTV, respectively; (2) FIG. 1c show one smartphone operating under portrait mode, meanwhile the mirrored displayed image on one HDTV that is wirelessly connected to the smartphone is instead operating under landscape mode. FIG. 1c shows a black border created on the right and left edges of the displayed image of the LCD monitor, respectively; (3) FIG. 1d show one smartphone operating under portrait mode, meanwhile the mirrored displayed image on one LCD monitor that is wirelessly connected to the smartphone is also operating under portrait mode. FIG. 1d shows a black border created on the top and bottom edges of the displayed image of the LCD monitor, respectively. In these above examples, the smartphone has a landscape mode and a portrait mode for screen viewing orientations; while some display devices such as TV may only support the landscape mode, that is capable of supporting just one viewing mode; thus when mirroring from a smartphone operating under the portrait mode to a HDTV operating under the landscape mode, the best fit display area requires to be considered as well.

In other examples, the true ratio of the width and the height between a local display device and a remote mirroring display device can be different; thus there needs to have a policy for the mirroring for the multiple display system. The traditional method for configuring the mirroring policy is to ensure the ratio of the width and the height to be kept the same between the original image and the mirrored image.

As can be seen from above, conventional mirroring systems and methods of multiple display devices have several drawbacks. In addition, actual displayed image quality at the highest resolution display device is sometimes being sacrificed or handicapped at the expense of the lowest resolution display device. Furthermore, because there is only one set of display frame buffer being streamed over from one connected display device to another connected mirrored display device at a given time, and that the down scale/upscale function is being performed via a LCD controller at a first display device to send to a second display device; therefore, the second display device even when it is of higher resolution, i.e. at full-HD 1080p, would still not be able to display mirrored multimedia content at its full HD resolution capability.

Therefore, there is room for improvement within the art.

### BRIEF DESCRIPTION OF THE DRAWINGS

FIGS. 1a˜1b show both a smartphone operating under landscape mode, and a HDTV wirelessly connected to the smartphone also operating under landscape mode.

FIGS. 1c˜1d show a smartphone operating under portrait mode, and a HDTV that is wirelessly connected to the smartphone operating under landscape mode.

FIG. 2 shows a process flow chart of an algorithm for implementing smart mirroring for the multiple display system according to a second embodiment of instant disclosure.

FIG. 3 shows a process flow chart of a method for rendering frame buffers for a video layer to the remote device and to the local device by decoding a video content to a frame buffer for a video layer.

### SUMMARY OF THE INVENTION

An objective of the present invention is to provide a method and system to smartly mirror image or multimedia content from one display device to another display device.

Another objective of the present invention is to provide a method and system for mirroring images, multimedia, and/or applications content for sharing between multiple display devices.

Another objective of the present invention is to provide a preferred usage configuration mode for a smart mirroring method for a multiple display system, in which multiple sets of display frame buffers are provided in which each set of compatible display frame buffer is correspondingly allocated for one display device having a particular resolution.

Another objective of the present invention is to provide a preferred usage configuration mode adapted for a smaller screen for the smart mirroring for a multiple display system, with a default setting for rendering is configured at the resolution of the display device with the lowest resolution.

Another objective of the present invention is to provide a preferred usage configuration mode adapted for larger screen for the smart mirroring for a multiple display system, in which the default setting for rendering is configured at the resolution of the display device with the highest resolution.

Another objective of the present invention is to provide a preferred usage configuration mode adapted for a balanced usage for both the smaller screen and the larger screen for the smart mirroring for a multiple display system.

Another objective of the present invention is to provide a multiple display system for allowing dynamic switching between the preferred usage configuration mode adapted for a smaller screen, the preferred usage configuration mode adapted for a larger screen, and the preferred usage configuration mode adapted for providing a balance usage between a smaller screen and a larger screen, for the smart mirroring thereof.

To achieve the above-said objectives, the present invention provides a configuration setting to customize the application so that more than one rendered images can be configured for various screen resolutions.

To achieve the above-said objectives, the present invention provides a system level API available to allow the application to render images into various canvases.

To achieve the above-said objectives, the present invention provides inherit support at the hardware side of the display devices to allow for the rendering of various display frame buffers to various display devices. This rendering does not have to go through the LCD controller etc. to a panel device, it can also go through a WWI display, such as through the connection to a remote device.

To achieve the above-said objectives, the present invention provides to have a system-level enhancement to provide SDK to allow rendering to various display devices, and the application is required to be aware of the system-level enhancement so as to be able to control the rendering.

The advantages of the mirroring method and the multiple display systems display devices of present disclosure are that the actual displayed image quality at the highest resolution display device is no longer being sacrificed at the expense of the lowest resolution display device so as to provide satisfactory user experience.

Furthermore, because there are now capabilities being set aside for the present disclosure for having a plurality of sets of display frame buffers being streamed over from one connected display device to another connected mirrored display device at a given time, and that the down scale/upscale function can be performed via a LCD controller; therefore, the second mirrored display device when it is of higher resolution, i.e. at full-HD 1080p, would now be able to display mirrored multimedia or image content at its full HD resolution capability from one of the display frame buffers being streamed from an image resource.

### DETAILED DESCRIPTION OF THE INVENTION

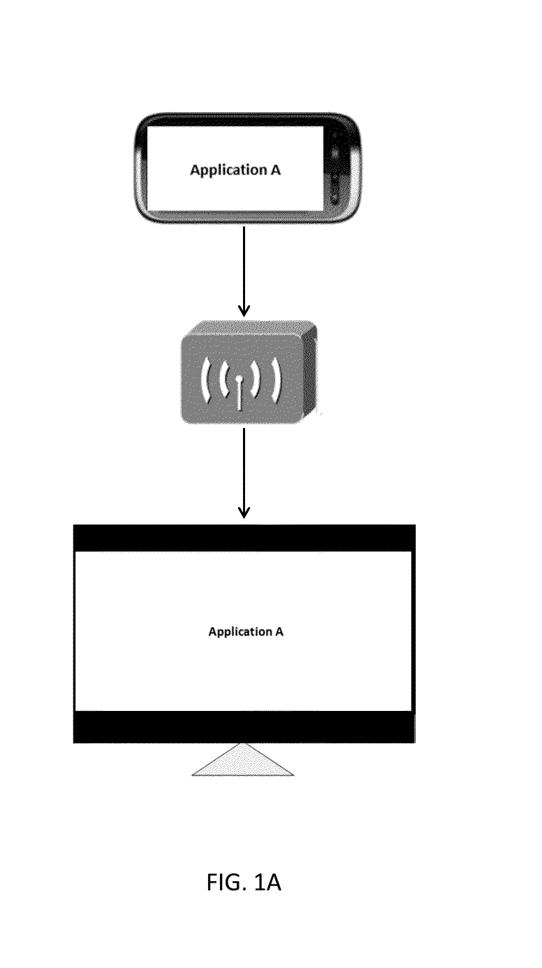

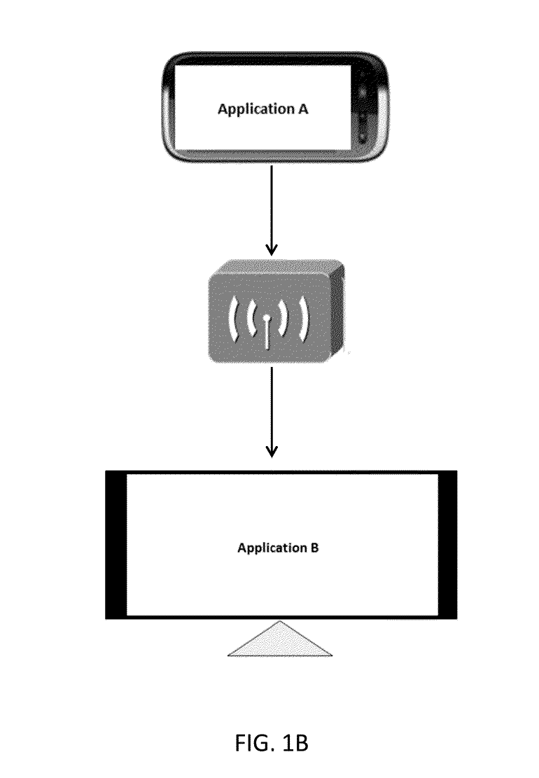

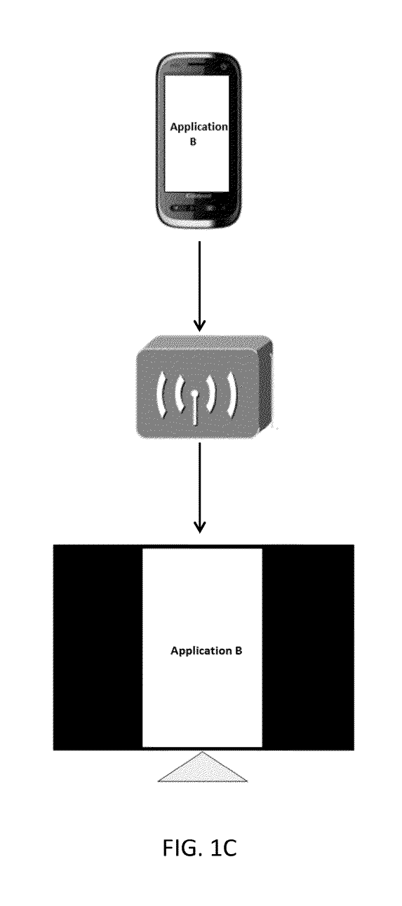

As shown in FIGS. 1a˜1d, a smartphone is treated as a master device which means that a display area will be governed by the width/height ratio of the smartphone. In an exemplified embodiment, a display area of a local device is the full screen; while the display area of a remote device may be part of the whole physical screen which is governed by the same width/height ratio (usually the screen's true width and height—this is to avoid the distortion caused by nonlinear scaling. In some mirroring implementation embodiments, nevertheless however, the same width/height ratio does not have to be maintained. In a multiple display system, each display device can be selected and treated as the master device to govern the display content, though usually it is the one tightly coupled with the master device that generates the source of display content.

According to a first embodiment of present disclosure, a method for implementing the smart mirroring for a multiple display system allows for dynamic switching between a preferred usage configuration mode adapted for a smaller screen, a preferred usage configuration mode adapted for a larger screen, and a preferred usage configuration mode adapted for a balanced usage for both the smaller screen and the larger screen. The method for implementing smart mirroring for the multiple display system includes a preferred usage configuration mode adapted for a smaller screen, a preferred usage configuration mode adapted for a larger screen, and a preferred usage configuration mode adapted for connecting together both a smaller screen and a larger screen.

First, the preferred usage configuration mode for a smaller screen, also referred to herein as a first usage mode, has a default setting configured to allow the application to render at the resolution of the display with the lowest resolution. Then for mirroring to a larger display at higher resolution, the corresponding image is then up-scaled from the lower resolution image of the smaller display when operating under this configuration mode.

Second, the preferred usage configuration mode for a larger screen, also referred to herein as a second usage mode, has a default setting configured to allow the application to render at the resolution of the display with the highest resolution. Then for mirroring to a smaller display at lower resolution, the corresponding image is then down-scaled from the higher resolution image of the larger display under this configuration mode.

Third, the preferred usage configuration mode for balanced usage for both the smaller screen and the larger screen connecting together, also referred to herein as a third usage mode, has an applicable configuration setting configured to customize the application so that it can create a plurality of rendered images configured for a plurality of screen resolutions. In the third usage mode, there is system level API available to allow the application to render images into various canvases. Meanwhile there will be inherit support at the hardware side to allow for the rendering of various display frame buffers to various display devices (the display device can be the local LCD panel, or can be an externally-connected projector or HDTV, or even a remote device with WIFI display connection, etc) according to the third usage mode. For the adoption of the preferred usage configuration mode for balanced usage for both smaller screen and larger screen connecting together, multiple sets of frame buffers are required, in which each set of display frame buffer is being used for each display device having a specific natural resolution. For the third usage mode, a system-level enhancement for the display device or a computer device providing the image resource or application resource is required to provide a SDK to allow rendering to various display devices, and the application is also required to be aware of this system-level enhancement so as to be able to control the rendering properly.

In this embodiment, the dynamic switching between the first, second and third usage modes can be performed based upon user preference with regard to preference given to the smaller screen, the larger screen, or to the balanced usage for both the smaller screen and the larger screen.

According to a second embodiment of present disclosure, a method for implementing the smart mirroring for a multiple display system includes an algorithm for determining and configuring an optimal displayed screen size for a mirrored remote display device.

In the second embodiment, a local display device includes a computer system therein, the whole screen image is shown by streaming on the display screen of the local display device, in which the displayed screen size for the local display device is the full screen thereof; the media resource content is also streamed to a remote display device by mirroring, and the displayed screen size for the mirrored remote display device is governed by either the width or height of the remote display screen with a given width/height ratio. In the second embodiment, the given width/height ratio is a fixed width/height ratio. In this embodiment, an originalRatio is defined as the width/height ratio of the original image on the local display device, and a remoteRatio is defined as the width/height ratio of the mirrored remote screen of the remote display device.

If the originalRatio is larger than the remoteRatio, a remoteDisplayedWidth is configured to be the width of the remote screen of the remote display device, and a remoteDisplayedHeight is configured to be the remoteDisplayedWidth/the originalRatio, therefore, equation 1 can be expressed as follow:

remoteDisplayedHeight=remoteDisplayedWidth/originalRatio [1]

If the originalRatio is not larger than the remoteRatio, the remoteDisplayedHeight is configured to be the height of the remote screen of the remote display device, and the remoteDisplayedWidth is configured to be the remoteDisplayedHeight multiply by the originalRatio, therefore, equation 2 can be expressed as follow:

remoteDisplayedWidth=remoteDisplayedHeight×originalRatio [2]

Thereafter, the optimal displayed screen size for a mirrored remote display device is determined and calculated to be the remoteDisplayedHeight for height, and the remoteDisplayedWidth for width.

In this embodiment, the area defined by the remoteDisplayedWidth and remoteDisplayedHeight is configured in the center of the respective display screen. In addition, the same width/height ratio between the original image and the mirrored image is not being kept or maintained, therefore, it is capable and possible to change the original width/height ratio and to be adapted to the entire screen of the remote display device.

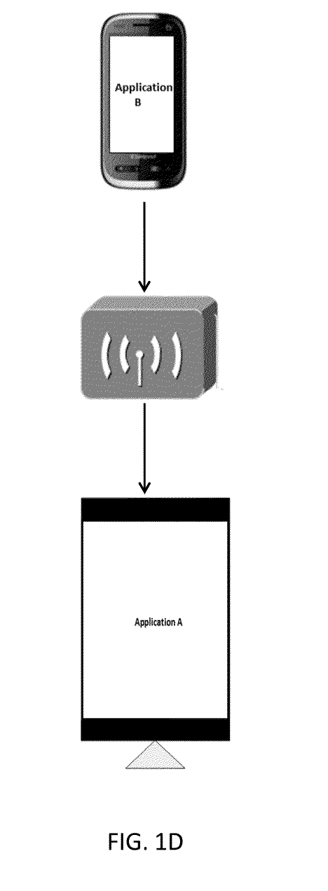

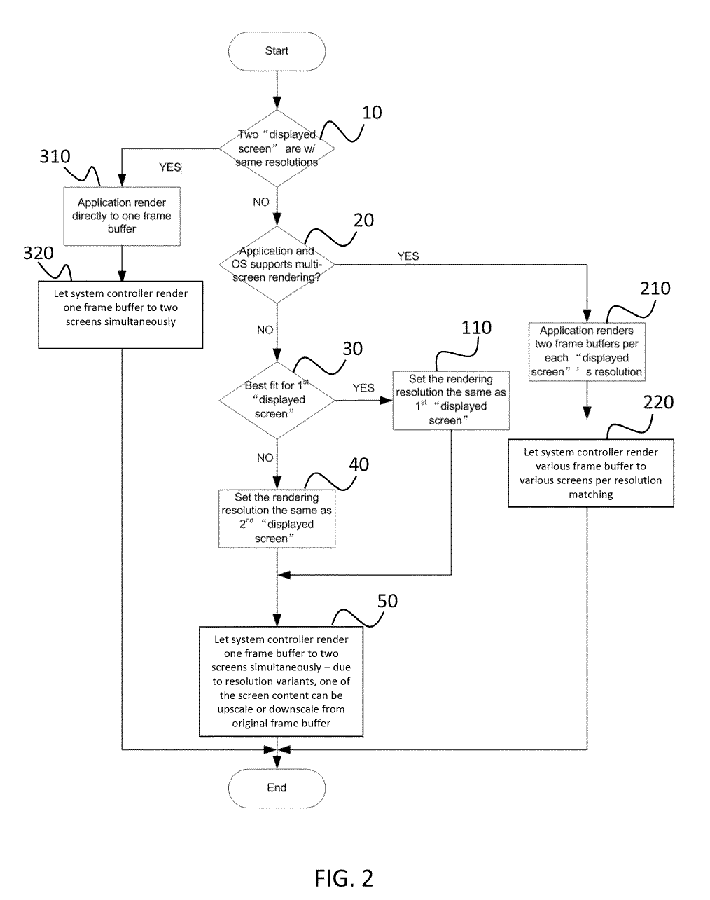

According to the second embodiment as shown in FIG. 2, a process flow chart of the algorithm for implementing the smart mirroring feature for the multiple display system according to instant disclosure include the following steps:

Step S10: determining if the two display screens for the local display device and the mirrored remote display device, respectively, are with the same resolution;

Step S20: determining if the application and the operating system residing on the computer system of the local display device support multi-screen rendering capability, and if the application and the operating system residing on the computer system of the local display device do provide support for multi-screen rendering capability, then in Step S210, application renders two frame buffers per each displayed screen (of the local display device and the remote display device) resolution; Step S220: Allow the system to render simultaneously two frame buffers to the two displayed screens of the local display device and the remote display device, respectively, and due to of not having resolution discrepancy, there is no need to upscale or downscale from the original set of frame buffer;

Step S30: determining if the displayed screen of the local display device is operating under one of the first usage mode and the second usage mode from the preferred usage configuration modes in the first embodiment;

Step S110: if the displayed screen of the local display device is found to operating under the first usage mode, the rendering resolution on the remote display device is to be set to be the same as the nature resolution of the displayed screen of the local display device;

Step S40: if the displayed screen of the local display device is found to operating under the second usage mode, the rendering resolution on the local display device is to be set to be the same as the natural resolution of the displayed screen of the remote display device; Step S50: Allow the system to render one original set of frame buffers to the two displayed screens of the local display device and the remote display device simultaneously, and due to potential resolution discrepancy, one of the displayed screen content, i.e. the remote display screen, can be up-scaled or down-scaled from the original set of frame buffer;

Step S310: if the two display screens for the local display device and the mirrored remote display device, respectively, are with the same resolution, application then renders directly to one frame buffer; Step S320: Allow the system to render simultaneously one set of frame buffers to two displayed screens of the local display device and the remote display device, respectively, in which the two displayed screens are of the same natural resolution.

Referring again to the second embodiment, the method for implementing smart mirroring for the multiple display system includes also the following steps: first, a local display device is to be connected to a remote display device, thereby forming the multiple display system; second, the whole screen image is initiated to be streamed and mirrored from the local display device to the remote display device; third, the aforementioned algorithm is then configured and implemented for performing the smart mirroring features for the multiple display system according to the second embodiment.

According to a third embodiment of the present disclosure, a system for mirroring images, videos, multimedia, and/or applications content for sharing between multiple display devices is configured and described as follows.

A first display device, also called a master display device, is connected to a second display device, also called a mirrored display device, via conventional wired or wireless means. The respective images displayed on the first display device are then streamed in real-time over to the second display device. The wireless transfer of display data can be done via WIFI, such as through IEEE 802.11a, b, g, and n WIFI networks. The display images are provided by an application resource or an image resource, i.e. a HD movie downloaded from the internet to the first display device.

The first display device is a smart HDTV that includes an operating system, a processor, a memory, and a built-in WIFI module; the operating system on the first display device is configured to provide system level API available to allow an application to render images into various canvases by supporting image rendering of multiple display frame buffers to both the first and second display devices. The system-level enhancement to the first display device provides SDK to allow for image rendering capability to multiple display devices, and the application running on the first display device is required to be aware of the system-level enhancement so as to be able to control the image rendering. In this embodiment, up to two sets of frame buffers can be provided to the first display device and the second display device, respectively, pending the result from the algorithm for determining an optimal displayed screen size for a mirrored second display device. Therefore, each set of compatible display frame buffer is correspondingly allocated for each connected display device having a particular resolution. Meanwhile, the down scale/upscale functions can be performed if required by the first display device via a LCD controller or similar system controller; and therefore, if the mirrored second display device is of higher resolution, i.e. at full-HD 1080p, and the application resource or the image resource does not have the required set of display frame buffer in the correct resolution needed by the second display device, the down scale/upscale by the first display device would still satisfy the mirroring of display images to the second display device.

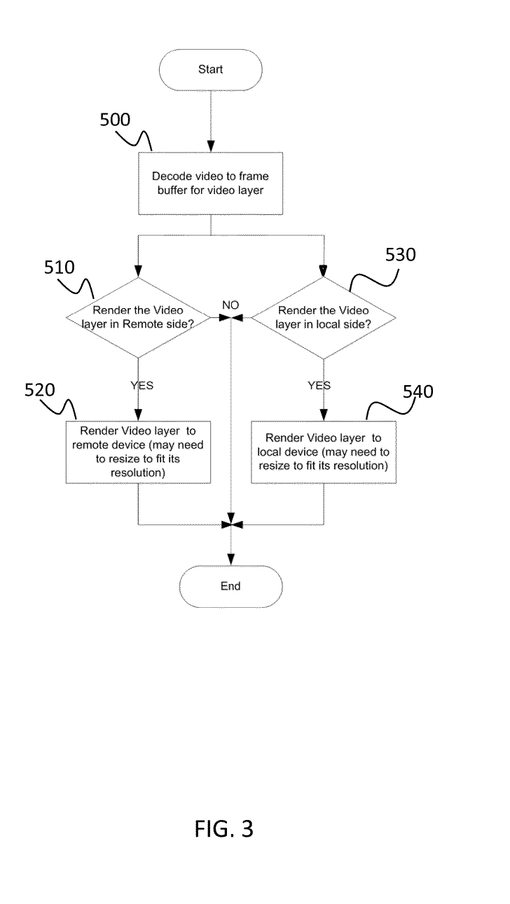

Referring to FIG. 3, according to a fourth embodiment of present invention, one image may contain multiple layers. In this embodiment, an original frame buffer is generated with a fixed resolution and can be rendered by system separately, in which a video content is decoded to the frame buffer for a video layer. An application can decode the video content per its original resolution to one frame buffer and the frame buffer can be composited and rendered separately to more than one display device accordingly, and does not have to be rendered to fit one screen resolution first, and then this composited image is used to be scaled again to fit a second screen resolution. As shown in the flow chart in FIG. 3, this method for rendering the video layer to the remote device and to the local device are described in the following steps:

Step S500: decoding a video content to frame buffer for a video layer;

Step S510: determining if required to rendering the video layer in the remote device pending user preference; Step S530: rendering the video layer to the remote device, and resizing to fit the resolution thereof if need be;

Step S520: determining if required to rendering the video layer in the local device pending user preference; Step S540: rendering the video layer to the local device, and resizing to fit the resolution thereof if need be.

It will be apparent to those skilled in the art that various modifications and variations can be made to the structure of the invention without departing from the scope or spirit of the invention. In view of the foregoing, it is intended that the present invention cover modifications and variations of this invention provided they fall within the scope of the following claims and their equivalents.

What is claimed is:

1. A method for implementing smart mirroring for a multiple display system, comprising:
providing a preferred usage configuration mode adapted for a smaller screen, a preferred usage configuration mode adapted for a larger screen, and a preferred usage configuration mode adapted for a balanced usage for both the smaller screen and the larger screen; and
performing dynamic switching between a preferred usage configuration mode adapted for a smaller screen, a preferred usage configuration mode adapted for a larger screen, and a preferred usage configuration mode adapted for connecting together both a smaller screen and a larger screen,
wherein the dynamic switching is performed based upon user preference with regard to preference given to the smaller screen, the larger screen, or to the balanced usage for both the smaller screen and the larger screen, the preferred usage configuration mode for the smaller screen having a default setting configured to allow an application to render at the resolution of the display with the lowest resolution, and mirroring to a larger display at a higher resolution, the corresponding image is then up-scaled; the preferred usage configuration mode for a larger screen having a default setting configured to allow the application to render at the resolution of the display with the highest resolution, and mirroring to a smaller display at lower resolution, the corresponding image is then down-scaled; the preferred usage configuration mode for the balanced usage for both smaller screen and larger screen customizing the application so that more than one rendered images are configured for a plurality of screen resolutions.

2. The method for implementing smart mirroring as claimed in claim 1, wherein in the preferred usage configuration mode adapted for connecting together both a smaller screen and a larger screen, a system level API is provided to allow the application to render images into more than one canvas, and inherit support is provided to allow for the rendering of more than one set of display frame buffers to more than one display device, thereby requiring of having multiple sets of display frame buffers, in which each set of display frame buffer is being used for each display device having a specific natural resolution.

3. The method for implementing smart mirroring as claimed in claim 2, wherein a system-level enhancement for the display device providing an image resource or an application resource from an application is required to provide SDK to allow rendering to the more than one display device, and the application is also required to be aware of the system-level enhancement so as to be able to control the image rendering.

4. A method for determining and configuring an optimal displayed screen size for a mirrored remote display device for a multiple display system when implementing smart mirroring, comprising the steps of:
providing a local display device,
displaying the whole image on the display screen of the local display device, and the displayed screen size for the local display device is the full screen thereof; and
streaming the media resource content to a remote display device by mirroring, and configuring the displayed screen size for the mirrored remote display device by the width or height of the remote display screen having a given width/height ratio.

5. A method for implementing smart mirroring for a multiple display system, comprising the steps of:
connecting a local display device to a remote display device;
initiating of media content streaming from the local display device to the remote display device; and
configuring and implementing an algorithm for performing the smart mirroring feature, the algorithm comprising:
determining if a local display device and a mirrored remote display device are respectively with the same resolution;
determining if an application residing on the local display device support multi-screen rendering capability;
if the application and the operating system residing on the local display device support multi-screen rendering capability, rendering two frame buffers per each displayed screen resolution of the local display device and the remote display device by the application; rendering two frame buffers to the local display device and the remote display device simultaneously, respectively, without upscaling or downscaling from the original set of frame buffers.

6. The method for implementing smart mirroring as claimed in claim 5, wherein the algorithm for performing the smart mirroring feature further comprising:
determining if the displayed screen of the local display device is operating under a preferred usage configuration mode adapted for a smaller screen; and
if the displayed screen of the local display device is found to operating under the preferred usage configuration mode adapted for the smaller screen, setting the rendering resolution on the remote display device to be the same as the nature resolution of the displayed screen of the local display device, rendering one original set of frame buffers to the two displayed screens of the local display device and the remote display device simultaneously, and upscaling or downscaling one of the displayed screen content from the original set of frame buffer.

7. The method for implementing smart mirroring as claimed in claim 5, wherein the algorithm for performing the smart mirroring feature further comprising:
determining if the displayed screen of the local display device is operating under a preferred usage configuration mode adapted for a larger screen; and
if the displayed screen of the local display device is found to operating under the preferred usage configuration mode adapted for a larger screen, setting the rendering resolution on the local display device to be the same as the natural resolution of the displayed screen of the remote display device, rendering one original set of frame buffers to the two displayed screens of the local display device and the remote display device simultaneously, and upscaling or downscaling one of the displayed screen content from the original set of frame buffer.

8. The method for implementing smart mirroring as claimed in claim 5, wherein the algorithm for performing the smart mirroring feature further comprising:
determining if a local display device and a mirrored remote display device are respectively with the same resolution; and
if the two display screens for the local display device and the mirrored remote display device, respectively, are of the same natural resolution, rendering directly to one set of frame buffer by the application, and rendering one set of the frame buffer by an LCD controller simultaneously to the local display device and the remote display device, respectively.

9. The method for implementing smart mirroring as claimed in claim 5, wherein further comprising a method for rendering frame buffers for a video layer, comprising the steps of:
decoding a video content to frame buffer for a video layer;
determining if rendering the video layer in the remote device pending user preference, and rendering the video layer to the remote device, and resizing to fit the resolution thereof if need be; and
determining if rendering the video layer in the local device pending user preference; rendering the video layer to the local device, and resizing to fit the resolution thereof if need be.
